(19) United States
(12) Patent Application Publication
(10) Pub. No.: US 2019/0361758 A1
(43) Pub. Date: Nov. 28, 2019

(54) STATUS DIAGNOSING SYSTEM FOR ROLLING GUIDE DEVICE AND STATUS DIAGNOSING METHOD

(71) Applicant: THK CO., LTD., Tokyo (JP)

(72) Inventors: Shuhei Yamanaka, Tokyo (JP); Yoshiyuki Honjo, Tokyo (JP)

(73) Assignee: THK CO., LTD., Tokyo (JP)

(21) Appl. No.: 16/479,425

(22) PCT Filed: Feb. 2, 2018
(86) PCT No.: PCT/JP2018/003607

§ 371 Date: Jul. 19, 2019

(30) Foreign Application Priority Data
Feb. 24, 2017 (JP) 2017-033921

(51) Int. Cl. G06F 11/07; F16C 29/06

(52) U.S. Cl. CPC G06F 11/0706; G06F 11/0754; F16C 29/0607; F16C 29/0688; G06F 11/079

(57) ABSTRACT

The state diagnosis system including: a sensor configured to detect a physical quantity exhibited when the moving member is moving along the track member; and a diagnosis processing unit configured to take in an output signal from the sensor, to thereby generate analysis data, compare the analysis data with threshold value data, determine whether the rolling guide device has an abnormality in accordance with a comparison result, and output a determination result, wherein the diagnosis processing unit has: a first processing mode of taking in the output signal from the sensor for a data collection time period T1, to thereby generate the analysis data; and a second processing mode of taking in the output signal from the sensor for a data collection time period T2 longer than the data collection time period Ti, to thereby generate the analysis data, and wherein the diagnosis processing unit outputs the determination result.

### TECHNICAL FIELD

The present invention relates to a state diagnosis system and a state diagnosis method, which are applied to a rolling guide device to be used in a linear guide portion or a curved guide portion of industrial machines such as machine tools or various conveying devices, and mechanically determine whether or not the rolling guide device is in an appropriate state.

### BACKGROUND ART

Hitherto, a rolling guide device of this type includes a track member and a moving member. The track member has a rolling surface for rolling elements, which extends along a longitudinal direction of the track member. The moving member is assembled to the track member through intermediation of a plurality of rolling elements which roll on the rolling surface, and is reciprocable along the track member. The moving member has a load rolling surface on which the rolling elements roll while bearing a load. The load rolling surface is opposed to the rolling surface of the track member to define a load path for the rolling elements. Further, the moving member has no-load paths for allowing the rolling elements to circulate from one end to another end of the load path. The load path and the no-load paths are continuous with one another to define an endless circulation path for the rolling elements. With such a configuration, the moving member is movable along the track member without being limited in stroke thereof.

A product lifetime of the rolling guide device mainly depends on fatigue in the rolling surface of the track member or the load rolling surface of the moving member. However, when the rolling surface and the load rolling surface as well as the rolling elements such as balls or rollers which roll thereon are not appropriately lubricated with lubricant or bear excessive loads, flaking of the rolling surface or the load rolling surface may occur early, with the result that the product lifetime of the rolling guide device is shortened. Further, the rolling guide device is applicable to various uses, and the progress of fatigue in the rolling surface or the like is inevitably affected by, for example, a use environment and an applied load depending on the use (hereinafter referred to as “use condition”), such as an environment in which special foreign matters fall onto the track member or a use under an environment of an extremely high or low temperature.

Thus, in order to allow the rolling guide device to exert its original performance and fulfill its product lifetime, it is desired that an operation condition of the rolling guide device be continuously detected by various sensors, to thereby allow recognition of the state of the rolling guide device, which is varied from hour to hour, based on the detected contents.

For example, for a rotary bearing, as described in Patent Literature 1, the following diagnosis system is proposed. Specifically, a sensor is used to detect sound, vibration, or acoustic emission generated at the time of a rotational operation of the rotary bearing, and an output signal from the sensor is analyzed. Then, a result of the analysis is compared with predetermined reference data to determine whether the rotary bearing has an abnormality.

### CITATION LIST

### Patent Literature

[PTL 1] JP 2004-93256 A

### DISCLOSURE OF THE INVENTION

### Problems to be Solved by the Invention

However, the moving member moves along the long track member in the rolling guide device. Therefore, even when it is possible to recognize that the rolling guide device has an abnormality based on the detection signal from the sensor, it is impossible to determine which of the track member and the moving member has an abnormality.

### Means for Solving the Problems

The present invention has been made in view of the above-mentioned problem, and therefore has an object to provide a state diagnosis system and a state analysis method, which are capable of appropriately recognizing a state of a rolling surface of a track member or no-load rolling surfaces of a moving member of the rolling guide device through use of a sensor mounted to the rolling guide device.

That is, the present invention relates to a state diagnosis system for a rolling guide device, and the rolling guide device includes: a plurality of rolling elements; a track member having a rolling surface for the rolling elements, the rolling surface extending along a longitudinal direction of the track member; and a moving member, which is assembled to the track member through intermediation of the rolling elements, and which includes an endless circulation path for the rolling elements, the endless circulation path including a load path for the rolling elements and no-load paths for coupling both ends of the load path. The state diagnosis system includes: a sensor configured to detect a physical quantity exhibited when the moving member is moving along the track member; and a diagnosis processing unit configured to take in an output signal from the sensor for a predetermined time period, to thereby generate analysis data, compare the analysis data with threshold value data, determine whether the rolling guide device has an abnormality in accordance with a comparison result, and output a determination result. The diagnosis processing unit has: a first processing mode of taking in the output signal from the sensor for a data collection time period T1, to thereby generate first analysis data, and comparing the first analysis data with first threshold value data; and a second processing mode of taking in the output signal from the sensor for a data collection time period T2 longer than the data collection time period T1, to thereby generate second analysis data, and comparing the second analysis data with second threshold value data. Further, the diagnosis processing unit is configured to determine which of the track member and the moving member causes the presence or absence of the abnormality of the rolling guide device in accordance with a combination of a comparison result in the first processing mode and a comparison result in the second processing mode and output the determination result.

Further, a state diagnosis method for a rolling guide device according to the present invention includes: a first step of taking in an output signal from the sensor for a data collection time period T1, to thereby generate first analysis data, and comparing the first analysis data with first threshold value data; a second step of, when the first analysis data is larger than the first threshold value data, taking in an output signal from the sensor for a data collection time period T2 longer than the data collection time period T1, to thereby generate second analysis data, and comparing the second analysis data with second threshold value data; and a third step of outputting a signal indicating an abnormality of the track member when the second analysis data is equal to or smaller than the second threshold value data.

### Effects of the Invention

According to the present invention, it is possible to appropriately recognize the state of the rolling surface of the track member and the no-load rolling surfaces of the moving member of the rolling guide device through use of the sensor mounted to the rolling guide device, thereby being capable of determining which of the track member and the moving member has an abnormality.

### BRIEF DESCRIPTION OF THE DRAWINGS

FIG. 1 is a perspective view for illustrating an example of a rolling guide device to which the present invention is applicable.

FIG. 2 is a sectional view for illustrating a configuration of balls in an endless circulation path.

FIG. 3 is a block diagram for illustrating an example of a configuration of a state diagnosis system according to the present invention.

FIG. 4 is a flowchart for illustrating a basic processing sequence of state diagnosis for the rolling guide device.

FIG. 5 are each a graph for showing an example of an output signal from a vibration sensor, in which FIG. 5(a) is a graph for showing a signal waveform when an operation of the rolling guide device is normal, and FIG. 5(b) is a graph for showing a signal waveform exhibited when a trouble has occurred in the operation of the rolling guide device.

FIG. 6 is a graph for showing a case in which a data collection time period T0 for the output signal from the vibration sensor is shorter than a cycle t.

FIG. 7 is a graph for showing a case in which a data collection time period T1 in a first processing mode is the same as the cycle t, and the operation of the rolling guide device is normal.

FIG. 8 is a graph for showing a case in which the data collection time period T1 in the first processing mode is the same as the cycle t, and a trouble has occurred in the operation of the rolling guide device.

FIG. 9 are each a graph for showing a relationship between the output signal from the vibration sensor and a data correction time period T2 in a second processing mode, in which FIG. 9(a) is a graph for showing a case in which a damaged portion is present in a part of a track member, and FIG. 9(b) is a graph for showing a case in which a trouble has occurred in a moving member.

FIG. 10 is a flowchart for illustrating a processing sequence of a state diagnosis method according to the present invention.

### MODE FOR CARRYING OUT THE INVENTION

Now, detailed description is made of a state diagnosis system and a state diagnosis method for a rolling guide device according to one embodiment of the present invention with reference to the accompanying drawings.

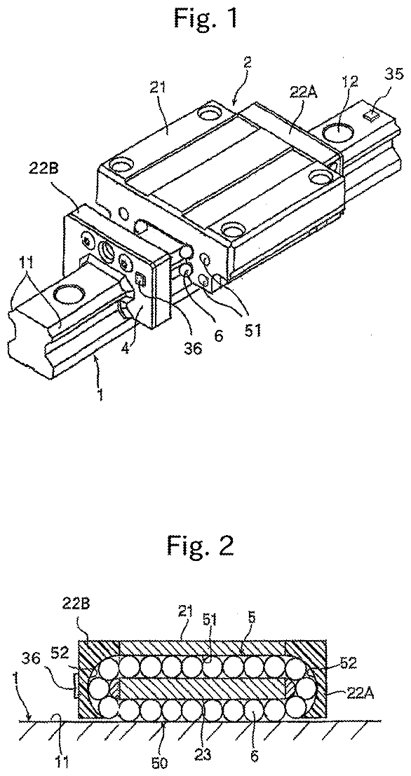

FIG. 1 is a perspective view for illustrating an example of a rolling guide device to which the present invention is applied. The rolling guide device includes a track member 1 and a moving member 2. The track member 1 extends linearly. The moving member 2 is assembled to the track member 1 through intermediation of a plurality of balls being rolling elements. The track member 1 is laid on a fixed portion of various machine tools, and a movable body of a type among various types is mounted to the moving member 2, thereby being capable of guiding the movable body along the track member 1 in a freely reciprocable manner.

The track member 1 is formed into an elongated body having a substantially rectangular cross section. The track member 1 has a plurality of bolt mounting holes 12, which are formed at predetermined intervals in a longitudinal direction and each penetrate from an upper surface to a bottom surface. With use of fixing bolts inserted into the bolt mounting holes 12, the track member 1 can be rigidly fixed to a fixing portion. On both right and left side surfaces of the track member 1, there are formed two rolling surfaces 11 for the rolling elements. The track member has four rolling surfaces 11 as a whole. The number of rolling surfaces 11 formed on the track member 1 is not limited to four.

Meanwhile, the moving member 2 mainly includes a main body member 21 made of metal, and a pair of covers 22A and 22B made of synthetic resin. The pair of covers 22A and 22B are mounted to both ends of the main body member 21 in a moving direction of the main body member 21. The moving member 2 has a plurality of endless circulation paths for the balls so as to correspond to the rolling surfaces 11 of the track member 1. Further, seal members 4, which are configured to seal gaps between the moving member 2 and the track member 1, are fixed to the covers 22A and 22B, thereby preventing dust or the like adhering to the track member 1 from entering the endless circulation paths. FIG. 1 is an illustration of a disassembled state in which one cover 22B of the pair of covers 22A and 22B mounted to the main body member 21 is removed from the main body member 21.

FIG. 2 is a sectional view for illustrating the endless circulation path. As illustrated in FIG. 2, the endless circulation path 5 includes a load path 50, a return path 51, and a pair of direction change paths 52. The main body member 21 forming the moving member 2 has a load rolling surface 23 opposed to the rolling surface 11 of the track member 1, and the rolling elements 6 roll between the rolling surface 11 of the track member 1 and the load rolling surface 23 of the main body 21 while bearing a load. In the endless circulation path 5, a path portion in which the rolling elements 6 roll while bearing the load corresponds to the load path 50. Further, the main body member 21 has the return path 51 extending parallel to the load path 50. Typically, the return path 51 is formed so as to penetrate through the main body member 21, and an inner diameter of the return path 51 is set so as to be slightly larger than a diameter of the rolling elements 6. With such a configuration, the rolling elements 6 roll in the return path without bearing the load.

The direction change paths 52 are formed in the pair of covers 22A and 22B, respectively. Those covers 22A and 22B are fixed to end surfaces of the main body member 21 so as to sandwich the main body member 21. The direction change path 52 of each of the covers 22A and 22B connects an end portion of the load path 50 and an end portion of the return path 51 to each other, and allows the rolling elements 6 to move therebetween.

Thus, when the pair of covers 22A and 22B are fixed to the main body member 21, the endless circulation path 5 for the rolling elements 6 is brought to completion. In the endless circulation path 5, the rolling elements 6 roll while bearing the load only in the load path 50 defined by the load rolling surface 23 of the main body member 21 and the rolling surface 11 of the track member 1, which are opposed to each other. Meanwhile, in the return path 51 and the direction change paths 52, the rolling elements 6 do not bear the load, and the return path 51 and the direction change paths 52 form no-load paths.

In the rolling guide device in the embodiment described with reference to FIG. 1 and FIG. 2, the balls are used as the rolling elements 6. However, the present invention is also applicable to a rolling guide device using rollers.

As illustrated in FIG. 1, a vibration sensor 35 is fixed to an end portion of the track member 1 in a longitudinal direction thereof. An acceleration sensor can be used as the vibration sensor 35. The vibration sensor 35 is configured to detect vibration generated when the moving member 2 and the track member 1 move relative to each other, and the vibration sensor 35 may be fixed to, for example, the main body member 21 of the moving member 2 instead of being fixed to the track member 1.

Meanwhile, a proximity sensor 36 is fixed to an outer side of the cover 22B. The proximity sensor 36 is fixed to the cover at a position of overlapping with the direction change path 52 formed in the cover 22B, and is configured to detect passage of each of the rolling elements 6 in the direction change path 52. The cover 22B is made of synthetic resin, and the rolling elements 6 are each made of metal. Therefore, through use of an induction-type or a capacitance-type proximity sensor, presence of the rolling elements 6 can be detected. In the example illustrated in FIG. 1, the proximity sensor 36 is provided so as to correspond to only one location among four locations of the direction change paths 52, which are formed in the cover 22B. However, a plurality of proximity sensors 36 may be provided so as to correspond to the respective direction change paths 52.

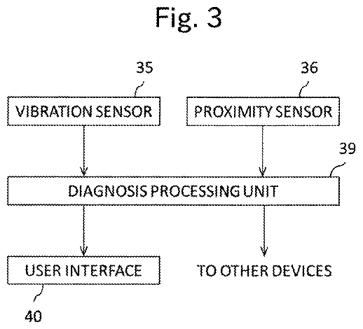

FIG. 3 is a block diagram for illustrating a configuration of a state diagnosis system for the rolling guide device using the vibration sensor 35 and the proximity sensor 36. Output signals from the vibration sensor 35 and the proximity sensor 36 are input to a diagnosis processing unit 39 through, for example, an A/D converter. The diagnosis processing unit 39 is implemented by a microcontroller including a RAM and a ROM. The diagnosis processing unit 39 executes a diagnosis program stored in advance in the ROM, and outputs a determination signal in accordance with a result of the diagnosis. The determination signal output by the diagnosis processing unit 39 is output to an alarm device or a user interface 40 such as a display.

The vibration sensor 35 is configured to detect an amplitude when the moving member 2 moves along the track member 1, and output the amplitude. The diagnosis processing unit 39 takes in the output signal from the vibration sensor 35 to process the output signal, to thereby generate analysis data indicating an intensity level of vibration. Further, in the ROM of the diagnosis processing unit 39, threshold value data indicating an intensity level of vibration exhibited when the rolling guide device is operating normally is recorded in advance, and the diagnosis processing unit 39 compares the generated analysis data with the threshold value data read out from the ROM, to thereby determine, based on a result of the comparison, whether or not some trouble has occurred in the operation of the rolling guide device.

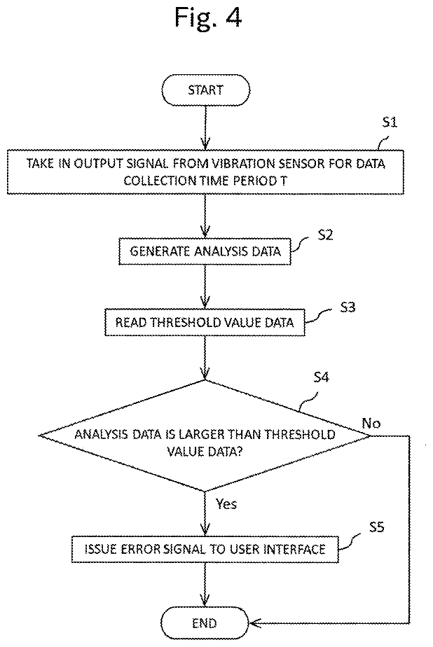

FIG. 4 is a flowchart for illustrating a basic processing sequence when it is determined in the diagnosis processing unit 39 whether or not the rolling guide device has an abnormality. The diagnosis processing unit 39 takes in an analog signal output from the vibration sensor 35 based on a predetermined sampling frequency for a predetermined data collection time period T (S1). A plurality of instantaneous values that have been taken in during the data collection time period T are subjected to root mean square (RMS) processing, to thereby become analysis data indicating a representative value in the data collection time period T (S2). This analysis data indicates an intensity level of vibration during the data collection time period T. The threshold value data to be compared with the analysis data is generated by the same processing as that for the analysis data under the state in which the rolling guide device is operating normally, for example, in an initial stage in which the track member 1 is laid on the fixed portion of various mechanical devices, is suitably weighted for ease of the comparison with the analysis data, and is then stored in the ROM of the diagnosis processing unit 39. Thus, through reading the threshold value data (S3), and comparing the analysis data with the threshold value data, it is possible to determine whether or not abnormal vibration is contained in running of the moving member 2 on the track member 1 (S4). As a result of this determination, when the value of the analysis data is larger than the threshold value data, abnormal vibration is contained in the running of the moving member 2 on the track member 1, and the diagnosis processing unit 39 issues a signal indicating the abnormality to the user interface 40 (S5).

In the basic diagnosis processing sequence illustrated in FIG. 4, it is possible to recognize that the rolling guide device has some abnormality, but it is not possible to distinguish which of the track member 1 and the moving member 2 causes the abnormality. Therefore, the diagnosis processing unit 39 combines a first processing mode and a second processing mode, which are different in the data collection time period T, to thereby determine which of the track member 1 or in the moving member 2 has the abnormality in accordance with a combination of the respective determination results in the first processing mode and the second processing mode. Processing details such as the generation of the analysis data and the comparison of the analysis data with the threshold value data are the same in the respective processing modes, but the first processing mode and the second processing mode are different from each other in the data collection time period T in which the output signal from the vibration sensor 35 is taken in.

The data collection time period in the first processing mode is T1. First analysis data indicating a representative value in the data collection time period T1 is generated in the first processing mode. The first analysis data is compared with first threshold value data. Moreover, the data collection time period in the second processing mode is T2. The data collection time period T2 is set to be longer than the data collection time period T1. Second analysis data indicating a representative value in the data collection time period T2 is generated in the second processing mode. The second analysis data is compared with second threshold value data.

The first processing mode is a mode of checking whether or not the rolling guide device has some abnormality. Now, description is made of how to determine the data collection time period T1 in the first processing mode.

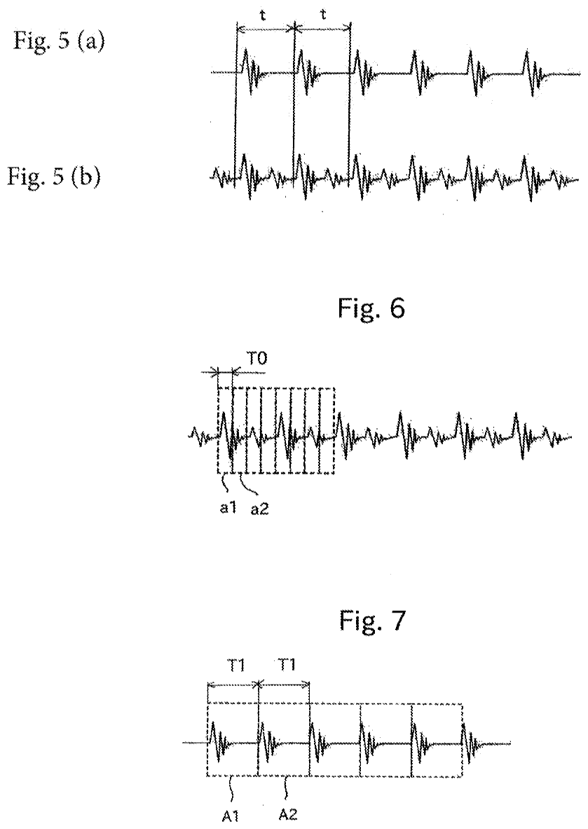

FIG. 5 are each a graph for schematically showing a waveform of the output signal from the vibration sensor 35, and the horizontal axis indicates time. FIG. 5(a) is a graph for showing a signal waveform of the output signal exhibited when the load rolling surface 23 of the moving member 2 and the rolling surface 11 of the track member 1 do not have a damage, and a lubrication state of the rolling elements 6 is normal, that is, when the rolling guide device is operating normally. When the rolling guide device is operating normally, changes in vibration having substantially the same level are regularly recorded at a cycle t in the output signal from the vibration sensor 35. The change in vibration at the cycle t occurs when the rolling element 6 enters the load path 50 from the direction change path 52. It is considered that, when the rolling element 6 enters the load path 50, the rolling element 6 is brought into strong contact with both of the rolling surface 11 of the track member 1 and the load rolling surface 23 of the moving member 2 to enter a state of bearing the load, and vibration is generated at this time. Accordingly, every time each of the rolling elements 6 enters the load path 50, the large change in vibration is recorded.

Meanwhile, FIG. 5(b) is a graph for showing a signal waveform of the output signal exhibited when some damage, for example, flaking, has occurred in the load rolling surface 23 of the moving member 2 or the rolling surface 11 of the track member 1, or the lubrication state of the rolling elements 6 is inappropriate, that is, when some trouble has occurred in the operation of the rolling guide device. In this case, irregular changes in vibration are recorded in a mixed manner in the output signal from the vibration sensor 35, in addition to the regular changes in vibration shown in FIG. 5(a).

As shown in the signal waveform of FIG. 5(a), under the state in which the rolling guide device is operating normally, vibration caused by entrance of the rolling element 6 into the load path 50 is repeatedly generated at the cycle t, and is recorded in the output signal from the vibration sensor 35. Accordingly, in a case where the data collection time period for taking in the output signal from the vibration sensor 35 is set to be shorter than the cycle t, even when the rolling guide device is operating normally, the magnitude of the intensity level of vibration indicated by the analysis data may extremely differ from that in the cycle t.

For example, as shown in FIG. 6, when a data collection time period T0 shorter than the cycle t is used, between a frame a1 and a frame a2, which have the same data collection time period but have different times to start data collection, the intensity level of vibration indicated by the analysis data differs depending on whether or not vibration generated when the rolling element 6 enters the load path 50 is contained. That is, the analysis data has a large variation depending on the time to start data collection, and hence, even when those pieces of analysis data are compared with the threshold value data, it is impossible to determine whether or not the rolling guide device is operating normally.

In this state, when the data collection time period T1 is set to T1=t in the first processing mode where t represents the cycle at which vibration caused by entrance of the rolling elements 6 into the load path 50 is generated, the vibration generated when the rolling element 6 enters the load path 50 is always contained in a frame A1 and a frame A2, which have different times to start data collection, as shown in FIG. 7. Accordingly, under the state in which the rolling guide device is operating normally, respective pieces of analysis data associated with the frame A1 and the frame A2 indicate substantially the same intensity level. The rolling guide device is operating normally in this case, and hence the intensity level at this time is the same as that of the threshold value data.

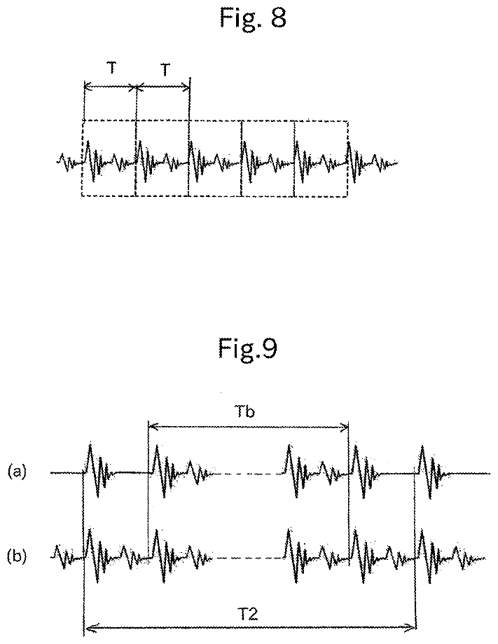

When the generation cycle t of the vibration caused by the entrance of the rolling elements 6 into the load path 50 is recognized, and the data collection time period T1 in the first processing mode is to t in such a manner, the first analysis data obtained in the first processing mode is correctly compared with the first threshold value data, thereby being capable of determining whether or not the rolling guide device is operating normally based on a difference in the comparison. As shown in FIG. 8, even when some trouble has occurred in the operation of the rolling guide device, the first analysis data generated under the condition that the data collection time period T is equal to t contains, in addition to vibration caused by entrance of the rolling element 6 into the load path 50, vibration caused by abnormal running of the moving member 2 relative to the track member 1, and hence the first analysis data indicates an intensity level higher than that of the first threshold value data. Accordingly, based on a result of comparison between the first analysis data and the first threshold value data, it is possible to determine that some trouble has occurred in the rolling guide device.

It is required to recognize the cycle t in order to implement the first processing mode. In this embodiment, the proximity sensor 36 detects passage of each of the rolling elements 6 in the direction change paths 52, and hence through checking of the output signal from the proximity sensor 36, it is possible to recognize an interval of passage between two rolling elements 6 moving back and forth, that is, to recognize the cycle t, at which the rolling element 6 enters the load path 50.

Further, the cycle t is uniquely determined based on a rolling speed of the rolling element 6 in the endless circulation path 5, that is, the moving speed v of the moving member 2 relative to the track member 1, and hence, when the moving speed v of the moving member 2 can be recognized by various sensors, it is not required to use the output signal from the proximity sensor 36. For example, a linear scale is provided along the track member 1, and an encoder configured to read the linear scale is provided to the moving member 2. In this case, the moving speed v of the moving member 2 is recognized based on an output signal from the encoder, and the cycle t can be recognized based on the moving speed v. Further, when the rolling guide device and a ball screw device is combined to construct a guide system, the moving speed v of the moving member 2 relative to the track member 1 depends on a rotation speed of a motor configured to drive the ball screw device, and hence the cycle t can be recognized by recognizing the rotation speed of the motor, or by obtaining the moving speed v of the moving member 2 from a controller of the guide system, which is configured to control rotation of the motor.

Meanwhile, the second processing mode is a mode of distinguishing which of the track member 1 and the moving member 2 caused the trouble that has occurred in the rolling guide device. Now, description is made of how to determine the data collection time period T2 in the second processing mode.

FIG. 9(a) is a graph for showing a signal waveform of the output signal from the vibration sensor 35 exhibited when damage has not occurred in the load rolling surface 23 of the moving member 2, but some damage, for example, flaking, has occurred in the rolling surface 11 of the track member 1. In this case, every time each of the rolling elements 6 rolling in the load path 50 of the moving member 2 passes a location of the track member 1 at which the damage has occurred, the waveform of the output signal from the vibration sensor 35 changes. The changes in vibration caused by the location of the track member 1 at which the damage has occurred occur only in a time period Tb in which the load path 50 of the moving member 2 is passing the damaged location on the track member 1, and do not occur after the load path 50 has passed the damaged location. This time period Tb can be given by Tb=L1/v, where L1 represents a length of the load path 50 of the moving member 2, and v represents a moving speed of the moving member 2 with respect to the track member 1. The moving speed v can be recognized from an output interval of the output signal from the proximity sensor 36 or the like.

In contrast, as indicated by the waveform of FIG. 9(b), when damage has not occurred in the rolling surface 11 of the track member 1, but some damage, for example, flaking, has occurred in a part of the load rolling surface 23 of the moving member 2, a change is recorded in the output signal from the vibration sensor 35 every time the rolling elements 6 pass the damaged location of the load rolling surface 23. The same waveform is thus repeatedly generated while the moving member 2 is moving along the track member 1.

In consideration of these points, the data collection time period T2 in the second processing mode is set so as to be longer than the time period Tb in which the load path 50 of the moving member 2 passes the damaged location on the track member 1. That is, as shown in FIG. 9, T2 is set as T2>Tb.

The analysis data generated by the diagnosis processing unit 39 is a value obtained by applying the RMS (root mean square) processing to the signal from the vibration sensor 35 output in the predetermined data collection time period. Thus, when the data collection time period T2 in the second processing mode is set as T2>Tb, the analysis data generated when the load rolling surface 23 of the moving member 2 has the damage (the signal waveform of FIG. 9 (b)) is certainly larger than the analysis data generated when the rolling surface 11 of the track member 1 has the damage present in a part thereof (the signal waveform of FIG. 9(a)), as apparent from a comparison between the waveforms shown in FIG. 9. From such a view point as clarifying the difference between the data collection time period T2 and the passage time period Tb of the moving member 2, it is preferred that the data collection time period T2 be set as T2≥Tb+t.

Moreover, as the data collection time period T2 increases compared with the passage time period Tb of the moving member 2, the difference in the value of the analysis data increases. The maximum value of the data collection time period T2 is the maximum movement time period tw of the moving member 2 in one direction with respect to the track member 1, and is given by T2≤tw=Lw/v, where Lw represents a stroke length of the moving member 2, and v represents the moving speed.

The second threshold value data to be compared with the second analysis data generated in the second processing mode can suitably be set to a value having such a magnitude that the signal waveform of FIG. 9(a) and the signal waveform of FIG. 9(b) can be distinguished. When the data collection time period T2 is sufficiently longer than the passage time period Tb of the moving member 2, the difference between the analysis data corresponding to the signal waveform of FIG. 9(a) and the analysis data corresponding to the signal waveform of FIG. 9(b) increases, and the second threshold value data in the second processing mode can thus easily be set accordingly. Moreover, the second threshold value data may be different from or the same as the value of the first threshold value data acquired under the state in which the rolling guide device is operating normally.

Description has been made of the example in which the data collection time period T1 in the first processing mode is set to T1=t, but the data collection time period T1 may be set to T1=nt (n is a natural number). However, the data collection time period T1 is required to be equal to or shorter than the passage time period Tb of the moving member 2 described for the second processing mode.

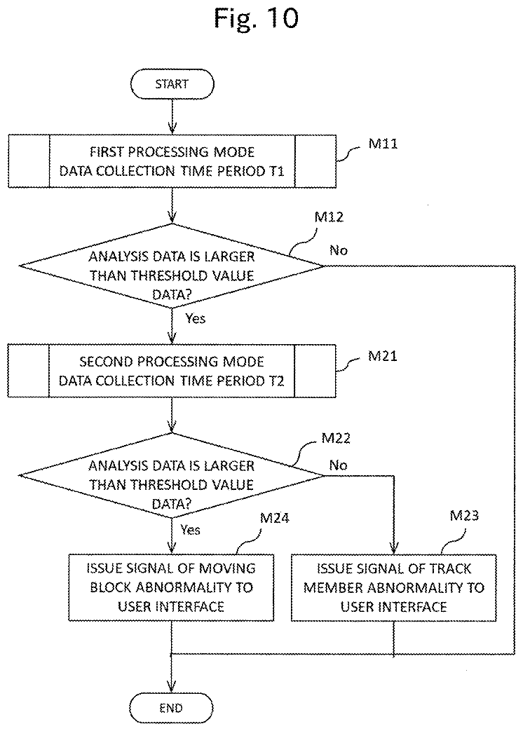

FIG. 10 is a flowchart for illustrating an example of a state diagnosis method executed by the state diagnosis system, and the first processing mode and the second processing mode are combined with each other.

In this diagnosis method, the diagnosis processing unit 39 first operates in the first processing mode (M11). The first processing mode corresponds to S1 to S3 of the diagnosis processing illustrated in FIG. 4, and the first analysis data corresponding to the data collection time period T1 is generated. The generated first analysis data is compared with the first threshold value data (M12). When the first analysis data obtained in the first processing mode is larger than the first threshold value data as a result of the comparison, a damage could have occurred in any of the rolling surface 11 of the track member 1 and the load rolling surface 23 of the moving member 2. In this case, the diagnosis processing unit 39 operates in the second processing mode subsequently to the first processing mode (M21). Moreover, when the first analysis data obtained in the first processing mode is equal to or smaller than the first threshold value data, it is considered that a damage has not occurred in any of the rolling surface 11 of the track member 1 and the load rolling surface 23 of the moving member 2, and the diagnosis processing unit 39 finishes the diagnosis method.

The second processing mode corresponds to S1 to S3 of the diagnosis processing illustrated in FIG. 4, and the second analysis data corresponding to the data collection time period T2 is generated. The generated second analysis data is compared with the second threshold value data (M22). When it is determined that the second analysis data obtained in the second processing mode is smaller than the second threshold value data as a result of the comparison, it is considered that a damage, for example, flaking, has occurred in a part of the rolling surface 11 of the track member 1. In this case, the diagnosis processing unit 39 issues a signal indicating the abnormality of the track member 1 to the user interface 40 (M23).

In contrast, when the second analysis data obtained in the second processing mode is larger than the second threshold value data, it is considered that a damage, for example, flaking, has occurred in the load rolling surface 23 of the moving member 2. In this case, the diagnosis processing unit 39 issues an error signal indicating the damage of the moving member 2 to the user interface 40 (M24). Also when a damage, for example, flaking, has occurred in a wide range of the rolling surface 11 of the track member 1, the output signal from the vibration sensor is similar to the signal waveform of FIG. 9 (b), and the second analysis data obtained in the second processing mode becomes larger than the second threshold value data. However, a major factor of the damage of the rolling surface 11 of the track member 1 is metal fatigue caused by the rolling of the rolling elements 6, and it is unlikely that a damage occurs at once to an entire range of the rolling surface 11. Thus, when an accumulated time of use of the rolling guide device is short, it can be determined that the state in which the second analysis data is larger than the second threshold value data is caused by a damage of the load rolling surface 23 of the second moving member 2.

The diagnosis processing unit 39 may be configured to, in addition to issuing the signal indicating the abnormality to the user interface 40, output the determination result to a device such as a machine tool or the like that uses the rolling guide device. Further, the diagnosis processing unit 39 may be configured to compare the first analysis data with the first threshold value data in the first processing mode, and issue a determination signal indicating that the running of the rolling guide device is normal to the user interface 40 when the diagnosis processing unit 39 determines that the first analysis data is equal to or smaller than the first threshold value data.

As described above, when a trouble has occurred in the rolling guide device, vibration occurs in the moving member 2 differently from a case in which the rolling guide device is operating normally. However, when a trouble has occurred in the rolling guide device, in addition to a change in vibration of the moving member 2, various changes in physical quantity occur differently from a case in which the rolling guide device is operating normally, such as a change in running sound generated when the moving member 2 is being moved along the track member 1 or a change in thrust force, or displacement of the moving member 2 on the track member 1. Accordingly, such changes in physical quantity may be detected by various sensors, and a detection signal from each sensor may be used to implement the state diagnosis in the present invention.

A sensor capable of recognizing a change in physical quantity generated when the moving member 2 and the track member move relative to each other can be used in place of the vibration sensor 35. Examples of the sensor include a displacement sensor configured to detect a minute displacement of the moving member 2 in a direction orthogonal to the longitudinal direction of the track member 1, a load cell configured to detect a change in thrust force required when the moving member 2 is to be moved at a constant speed, an ammeter configured to detect current flowing through the motor configured to drive the ball screw device of the guide system, and a microphone configured to detect a change in sound generated when the moving member 2 is moving along the track member 1.

As described above, in the state diagnosis system and the state diagnosis method for a rolling guide device according to the present invention, vibration of the moving member 2 moving along the track member 1 is detected by the sensor, and based on the output signal from the sensor, it is determined whether or not some trouble has occurred in the rolling guide device. In this state, the diagnosis processing unit 39 that takes in the output signal from the sensor has the first processing mode and the second processing mode, which are different from each other in the data collection time period, and combines the determination results of these two processing modes, to thereby be able to determine which of the track member 1 and the moving member 2 causes the trouble of the rolling guide device.

The rolling guide device in the embodiment described with reference to the drawings is of a type in which the track member 1 is laid on the fixed portion. However, the present invention is also applicable to a rolling guide device such as a ball-spline device or a ball screw device of a type in which the track member is formed into a rod shaft shape such that only both ends thereof are supported by the fixed portion.

1. A state diagnosis system for a rolling guide device,
the rolling guide device including:
a plurality of rolling elements;
a track member having a rolling surface for the rolling elements, the rolling surface extending along a longitudinal direction of the track member; and
a moving member, which is assembled to the track member through intermediation of the rolling elements, and which includes an endless circulation path for the rolling elements, the endless circulation path including a load path for the rolling elements and no-load paths for coupling both ends of the load path,
the state diagnosis system comprising:
a sensor configured to detect a physical quantity exhibited when the moving member is moving along the track member; and
a diagnosis processing unit configured to take in an output signal from the sensor for a predetermined time period, to thereby generate analysis data, compare the analysis data with threshold value data, determine whether the rolling guide device has an abnormality in accordance with a comparison result, and output a determination result,
wherein the diagnosis processing unit has:
a first processing mode of taking in the output signal from the sensor for a data collection time period T1, to thereby generate first analysis data, and comparing the first analysis data with first threshold value data; and
a second processing mode of taking in the output signal from the sensor for a data collection time period T2 longer than the data collection time period T1, to thereby generate second analysis data, and comparing the second analysis data with second threshold value data,
wherein the diagnosis processing unit is configured to determine which of the track member and the moving member causes the presence or absence of the abnormality of the rolling guide device in accordance with a combination of a comparison result in the first processing mode and a comparison result in the second processing mode and output the determination result.

2. The state diagnosis system for a rolling guide device according to claim 1, wherein only when the rolling guide device is determined to have the abnormality in accordance with the comparison result of the first analysis data with the first threshold value data in the first processing mode, the second analysis data is compared with the second threshold value data in the second processing mode.

3. The state diagnosis system for a rolling guide device according to claim 1, wherein the data collection time period T1 in the first processing mode is T1=nt (n is a natural number) where t represents a cycle in which preceding and following rolling elements in the endless circulation path enter the load path from the no-load paths.

4. The state diagnosis system for a rolling guide device according to claim 1, wherein the state diagnosis system is configured to:
detect a moving speed of the moving member relative to the track member; and
recognize the cycle t based on a result of the detection.

5. The state diagnosis system for a rolling guide device according to claim 3, wherein the data collection time period T2 in the second processing mode is T2>L1/v, where v represents a moving speed of the moving member with respect to the track member, and L1 represents a length of the load path.

6. A state diagnosis method applied to a rolling guide device,
the rolling guide device including:
a plurality of rolling elements;
a track member having a rolling surface for the rolling elements, the rolling surface extending along a longitudinal direction of the track member; and
a moving member, which is assembled to the track member through intermediation of the rolling elements, and which includes an endless circulation path for the rolling elements, the endless circulation path including a load path for the rolling elements and no-load paths for coupling both ends of the load path,
the state diagnosis method taking in, by a sensor, a change in a physical quantity exhibited for a predetermined time period when the moving member is moving along the track member, to thereby generate analysis data, and comparing the analysis data with threshold value data, to thereby determine whether the rolling guide device has an abnormality,
the state diagnosis method comprising:
a first step of taking in an output signal from the sensor for a data collection time period T1, to thereby generate first analysis data, and comparing the first analysis data with first threshold value data;
a second step of, when the first analysis data is larger than the first threshold value data, taking in an output signal from the sensor for a data collection time period T2 longer than the data collection time period T1, to thereby generate second analysis data, and comparing the second analysis data with second threshold value data; and
a third step of outputting a signal indicating an abnormality of the track member when the second analysis data is equal to or smaller than the second threshold value data.

7. The state diagnosis method for a rolling guide device according to claim 6, wherein a signal indicating an abnormality of the moving member is output when the second analysis data is equal to or larger than the second threshold value data.

8. The state diagnosis method for a rolling guide device according to claim 6, wherein the data collection time period T1 is T1=nt (n is a natural number), where t represents a cycle in which preceding and following rolling elements in the endless circulation path enter the load path from the no-load paths.

9. The state diagnosis method for a rolling guide device according to claim 8, wherein the data collection time period T2 in the second processing mode is T2>L1/v where v represents a moving speed of the moving member with respect to the track member, and L1 is a length of the load path.
